(19) United States
(12) Patent Application Publication
(10) Pub. No.: US 2010/0036990 A1
(43) Pub. Date: Feb. 11, 2010

(54) NETWORK DEVICE

(75) Inventors: WEN-YUAN WANG, Tu-Cheng (TW); CHIEN-PAN LAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/211,036

(22) Filed: Sep. 15, 2008

(30) Foreign Application Priority Data
Aug. 8, 2008 (CN) 200810303628.3

(51) Int. Cl. G06F 13/00

(52) U.S. Cl. 710/301

(57) ABSTRACT

A network device includes a bus, at least one line card with a chip select pin and an address, and a control card module. The control card module includes at least one active control card connected to each line card. The control card module indentifies the line cards by the value of the chip select pin and the address so as to transmit data to the line card.

### BACKGROUND OF THE INVENTION

1. Field of the Invention

The present invention relates to network devices and particularly to a network device utilizing an inter-integrated circuit bus.

2. Discussion of the Related Art

Network devices, such as gateways, generally include at least one control card and a plurality of line cards connected by a bus and corresponding memory units. The line cards connect to subscribers by adaptors. The adapters also connect to the control cards so that the control card is capable of identifying line cards by reading the information stored on the adaptors.

FIG. 4 shows a typical inter-integrated circuit bus (I2C bus). The I2C bus is a serial bus with two lines, including serial data (SDA) and serial clock (SCL) lines. With the I2C bus, the control card 50 serves the slave devices 60a, 60b, and 60c connected to the I2C bus. Each slave device 60a, 60b, and 60c includes a complex programmable logic device (CPLD) for storing information thereof, such as the addresses of I2C protocol of the slave devices 60a, 60b, and 60c.

Although it is free to utilize the I2C protocol, manufactures must pay for the addresses occupied by the slave devices connected to the I2C bus. One solution to this is to set up a logic circuit, such as a multiplexer, for selecting slave devices with the same I2C addresses to conserve I2C addresses. However, the logic circuit prolongs the response time of the network devices.

Therefore, there is room for improvement within the art.

### BRIEF DESCRIPTION OF THE DRAWINGS

Many aspects of the network device can be better understood with reference to the following drawings. The components in the drawings are not necessarily to scale, the emphasis instead being placed upon clearly illustrating the principles of the present network device. Moreover, in the drawings, like reference numerals designate corresponding parts throughout the several views.

FIG. 1 is an isometric view of the network device according to an exemplary embodiment.

FIG. 2 is a system view of the connections between the bus, the control card module, and the line cards of the network device of FIG. 1.

FIG. 3 is a flowchart illustrating a method for querying the line cards of the network device of FIG. 1 after a boot procedure.

FIG. 4 is a system view of the connections between the bus, control card module, and line cards of a typical network device.

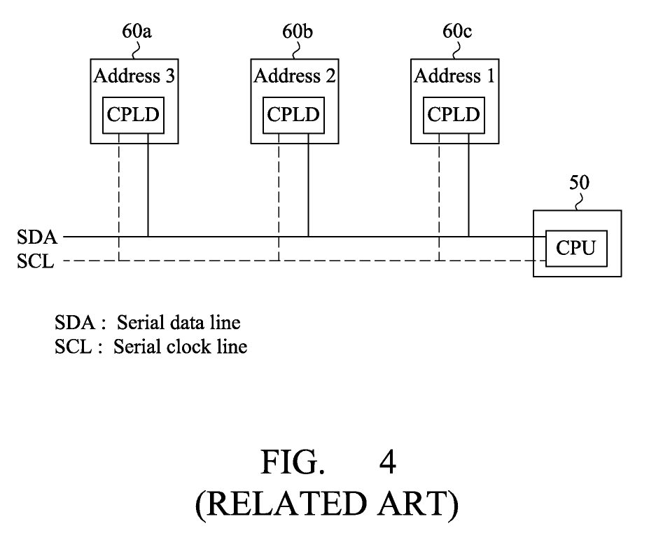

### DETAILED DESCRIPTION OF THE EMBODIMENTS

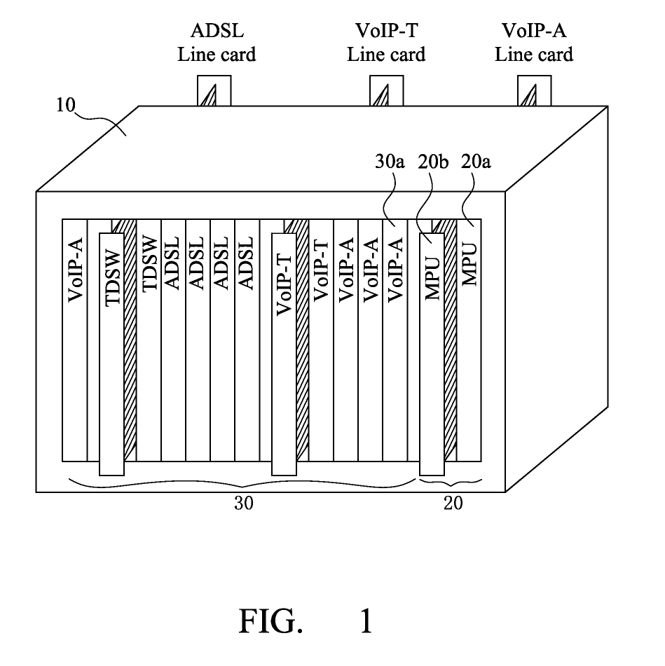

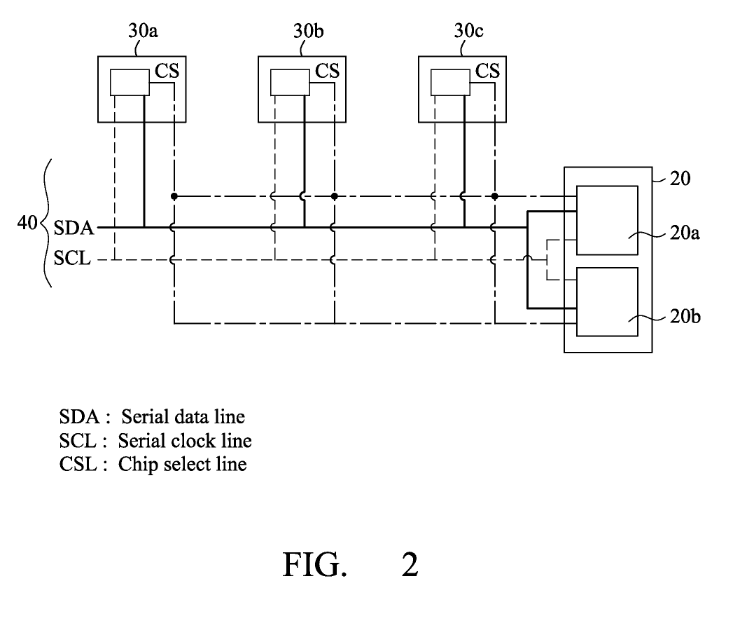

FIGS. 1 and 2 show a network device including a chassis 10, a control card module 20, a line card module 30 and a bus 40. As an example, the control card module 20 includes at least one active control card 20a and at least one standby control card 20b. In alternative embodiments, the control card module 20 can include more than two control cards.

The line card module 30 includes at least one line card 30a. Each line card 30a includes a CPLD storing address information. Additionally, each line card 30a also includes a chip-select (CS) pin. As an example, the line card module 30 includes a VoIP line card and an ADSL line card.

The active control card 20a of the control card module 20 can be connected to a plurality of line cards 30a, 30b, and 30c by the bus 40, rendering the control card module 20 capable of transmitting data to and receiving data from the lines cards 30a, 30b, and 30c over the I2C protocol by the bus 40. As an example, the addresses of the line cards 30a, 30b, and 30c are I2C address.

The bus 40 includes a SDA line transmitting data, a SCL line transmitting clock information and a chip-select line (CSL). Each line card 30a, 30b, and 30c connects to one end of the SDA line, and the other end of the SDA line connects to the active control card 20a. Each line card 30a, 30b, and 30c connects to one end of the SCL line, and the other end of the SCL line connects to the active control card 20a. Additionally, the active control card 20a connects to each line card 30a, 30b, and 30c by the CSL transmitting the values of the CS pins, either high or low, set by the active control card 20a.

Additionally, the standby control card 20b of the control card module 20 also includes pins (not shown) connected to the SDA line, SCL line and the CSL. Therefore, if the active control card 20a fails, the standby control card 20b can transmit data to the line cards 30a, 30b, and 30c over the I2C protocol.

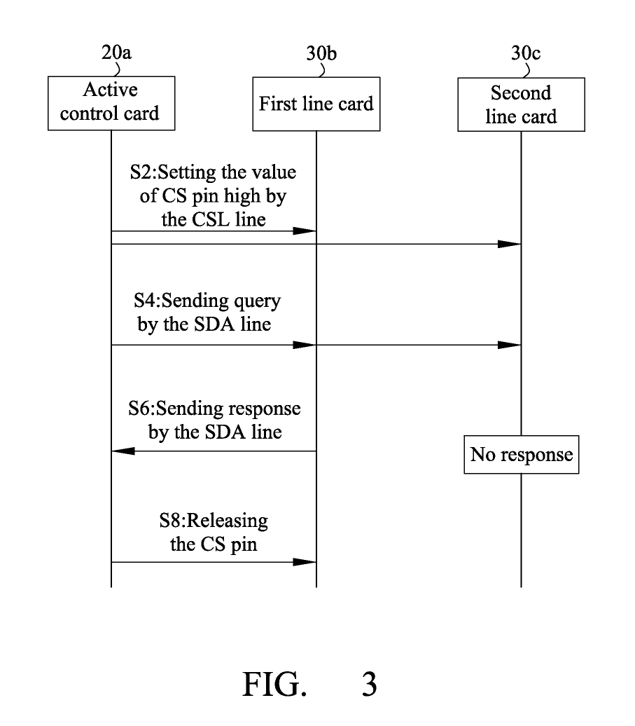

FIG. 3 illustrates a method for querying the line cards of the network device after a boot procedure. The exemplary network device includes an active control card 20a, a first line card 30b and a second line card 30c. In step S2, the active control card 20a sets the value of the CS pin. That the active control card 20a connects to the first line card 30b and the second line card 30c using different CSLs so that the values of the CS pins are transmitted to the first line card 30b and second line card 30c, respectively by the CSL. Therefore, the value of the CS pin of the active control card 20a is known to all the line cards 30b, 30c. As an example, the active control card 20a sets the value of the CS pin high.

In step S4, the active control card 20a sends a query by the SDA line of the I2C bus. The query indicates the address of the first line card 30b receiving the data. As an example, the first line card 30b and the second line card 30c have the same address, i.e., I2C address. When the value of the CS pin is set high, the active control card 20a will transmit data to the first line card 30b. When the value of the CS pin is set low, the active control card 20a will transmit data to the second line card 30c. In brief, the active control card 20a identifies the first line card 30b and the second line card 30c by the value of the CS pin and the addresses of the first line card 30b and the second line card 30c.

When receiving the query, in step S6, the first line card 30b sends a response by the SDA line. After the response is received by the active control card 20a, the active control card 20a transmits the data to the first line card 30b by the SDA line and transmits the clock information by the CSL to synchronize the active control card 20a with the first line card 30b. In step S8, the active control card 20a releases the CS pin.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A network device comprising:
a bus;
at least one line card comprising a chip select pin and an address; and
a control card module comprising at least one active control card, connected to each line card by the bus;
wherein the active control card indentifies each line card by the value of the chip select pin and the address, to transmit data to the selected line cards.

2. The network device as claimed in claim 1, wherein the bus comprises a serial data line, a serial clock line and a chip select line, and one end of each line connects to each line card and the other end of each line card connects to the active control card.

3. The network device as claimed in claim 2, wherein the control card module further comprises a standby control card connected to the serial data line, the serial clock line and the chip select line, and the standby control card transmitting data to the line cards if the active control card fails.

4. The network device as claimed in claim 3, wherein the active control card sets the value of the chip select pin, and then transmits the value of the chip select pin by the chip select line.

5. The network device as claimed in claim 4, wherein the active control card further sends a query by the serial data line and the query indicates the address of the line card for the transmission.

6. The network device as claimed in claim 5, wherein when the value of the chip select pin is set high, the line card with the value of the chip select pin set high receives the data from the active control card.

7. The network device as claimed in claim 5, wherein when the value of the chip select pin is set low, the line card with the value of the chip select pin set low receives the data from the active control card.
